(19) United States
(12) Patent Application Publication
(10) Pub. No.: US 2002/0119822 A1
(43) Pub. Date: Aug. 29, 2002

(54) Systems and methods wherein a player device continues game play independent of a determination of player input validity

(76) Inventors: Adrian E. Kunzle, New York, NY (US); V. Maximillian Garcia, New Haven, CT (US)

Correspondence Address: BUCKLEY, MASCHOFF, TALWALKAR, & ALLISON, 5 ELM STREET, NEW CANAAN, CT, 06840, US

(21) Appl. No.: 09/795,740

(22) Filed: Feb. 28, 2001

(51) Int. Cl. G06F 17/00

(52) U.S. Cl. 463/42

(57) ABSTRACT

Systems and methods are provided wherein a player device continues game play independent of a determination of player input validity. According to one embodiment, a game controller receives a player input from a remote player device via a communication network. For example, the game controller may receive a batch of player inputs from a player device via the Internet. The game controller then determines if the received player input is valid based on a game condition while the remote player device continues game play independent of any indication of validity from the game controller.

### FIELD

The present invention relates to games. In particular, the present invention relates to systems and methods wherein a player device continues game play independent of a determination of player input validity.

### BACKGROUND

Many players enjoy playing computer-based games, such as fast paced arcade-style games (e.g., games in which a player uses skill, such as his or her planning and reflexes, to achieve a goal). Examples of arcade-style games include computer-based maze games, racing games, fighting games, shooting games, and flying games. In a computer-based maze game, for example, a player typically moves about within a twodimensional or three-dimensional maze (e.g., by moving an icon or other representation associated with the player). The player may, for example, provide player inputs (e.g., “.up,” “down,” “left,” or “right”) to control his or her movement within the maze in attempt to achieve a goal (e.g., exiting the maze or obtaining items located within the maze). Generally, the player uses a keyboard and/or a computer mouse to generate these player inputs.

A player's movement within a computer-based maze game is, of course, restricted by walls or other obstacles within the maze. That is, only certain player inputs will be “valid” based on the configuration of the maze. For example, a player located between two walls may be allowed to move “up” or “down” but be prevented from moving “left” or “right.” A computer program adapted to provide game play typically verifies whether or not a player input is valid based on the configuration of the maze (e.g., the computer program will prevent the player from moving through a wall).

Many players also enjoy playing other types of games, such as games involving simulated physics. In a computer-based golf game, for example, a physics simulation (e.g., a computer program) calculates a trajectory of a simulated golf ball in accordance with a set of player inputs, (e.g, a golf club type, a golf club velocity, and/or an angular measurement associated with a swing of a golf club). The player may continue to provide player inputs (e.g., by taking additional swings) until the simulated golf ball comes to rest in a simulated golf hole. In this case, a player may be allowed to shoot the simulated golf ball around, but not through, an obstacle (e.g., a tree or a windmill).

One way a player can play a game, such as any of the games described above, is via a player device. For example, a player may use his or her Personal Computer (PC) to access a Web site associated with a game provider.

Some players, however, may try to use an automated game playing device to unfairly help them during game play. For example, a player may alter a game program stored at his or her PC to make game play easier. In the case of a maze game, the altered game program may, for example, let the player move through walls or other obstacles within a maze (or even “jump” to a distant location within the maze) providing him or her with an unfair advantage.

Instead of altering a game program, a player may create an automated game playing device that mimics signals or other outputs generated by the game program. For example, the automated game playing device may indicate that the player has performed certain actions in a game that would not normally have been possible (e.g., by indicating that the player has obtained items are not present within a maze).

In a game involving multiple players, such an automated game playing device may be a concern to other players, who can become discouraged if they are unable to compete with the automated game playing device. This will be particularly true if the players have provided payment in exchange for playing the game and/or are competing for a prize.

In addition to being a concern to other players, automated game playing devices can pose problems for game providers. Consider, for example, a game provider that promises to pay one thousand dollars to every player who successfully completes a computer-based maze game in less than thirty seconds. In this case, an automated game playing device may result in the game provider paying out an unfairly large number of prizes.

To discourage the use of automated game playing devices, game play can be made dependent on verification of player inputs by a game provider. For example, a player may provide a player input via a player device (e.g., via his or her PC) indicating that the player wants to move “up” within a maze. The player device transmits the player input to a remote game controller, which verifies that the player input is valid based on the configuration of the maze. After the game controller verifies the player input, the remote player device moves the player within the maze. In this way, the player cannot alter the game program at the player device so as to let the player, for example, move through walls.

Such an approach, however, slows down game play at the player device. That is, because each player input is verified before the player is moved within the maze, the player device is not able to provide the type of smooth, fast paced game play that player's enjoy.

Another problem with such an approach is that the game provider will unnecessarily verify some player inputs. That is, the game provider will verify player inputs even if a player does not, for example, eventually complete the maze. This problem may be especially serious if, for example, a large number of players are playing the game (e.g., via a Web site associated with the game provider).

### SUMMARY

To alleviate problems inherent in the prior art, the present invention introduces systems and methods wherein a player device continues game play independent of a determination of player input validity.

According to one embodiment, a player input is received at a game controller from a remote player device via a communication network. It is determined if the received player input is valid based on a game condition, and the remote player device continues game play independent of any indication of validity from the game controller.

Another embodiment is directed to facilitating game play at a game controller, wherein game play is associated with a game of skill in which a player moves within a maze. According to this embodiment, it is arranged for the player to provide payment in exchange for game play. A batch of player moves is received from a remote player device via a communication network, and game play is re-created at the game controller to determine if each of the received batch of player moves is valid. If each of the received batch of player moves is valid, a game result is certified and it is arranged for the player to receive payment of a monetary amount based on the certified game result.

Another embodiment is directed to facilitating game play at a player device. According to this embodiment, a player input is transmitted to a remote game controller via a communication network, and game play continues independent of any indication of validity from the game controller. The game controller then determines if the transmitted player input is valid based on a game condition.

One embodiment of the present invention comprises: means for receiving a player input from a remote player device via a communication network; and means for determining if the received player input is valid based on a game condition, wherein the remote player device continues game play independent of any indication of validity from the game controller.

Another embodiment comprises: means for arranging for a player to provide payment in exchange for game play; means for receiving a batch of player moves from a remote player device via a communication network; means for re-creating game play at a game controller to determine if each of the received batch of player moves is valid; means for certifying a game result if each of the received batch of player moves is valid; and means for arranging for the player to receive payment of a monetary amount based on the certified game result.

Another embodiment comprises: means for transmitting a player input to a remote game controller via a communication network; and means for continuing game play independent of any indication of validity from the game controller, wherein the game controller determines if the transmitted game input is valid based on a game condition.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of a game system according to an embodiment of the present invention.

FIG. 2A is a flow chart of a method for facilitating game play according to an embodiment of the present invention.

FIG. 2B illustrates two game displays according to an embodiment of the present invention.

FIG. 3 is a block diagram of a player device according to an embodiment of the present invention.

FIG. 4 is a block diagram of a game controller according to an embodiment of the present invention.

FIG. 5 is a tabular representation of a portion of a player database according to an embodiment of the present invention.

FIG. 6 is a tabular representation of a portion of a player input database according to an embodiment of the present invention.

FIG. 7 is a tabular representation of a portion of a game condition database according to an embodiment of the present invention.

FIG. 8 is a flow chart of a computer-implemented method for facilitating game play at a game controller according to an embodiment of the present invention.

FIG. 9 is a flow chart of a method for facilitating game play at a player device according to an embodiment of the present invention.

FIGS. 10A through 10C illustrate player devices displaying game information according to some embodiments of the present invention.

### DETAILED DESCRIPTION

Embodiments of the present invention are directed to systems and methods wherein a player device continues game play independent of a determination of validity associated with a “player input.” As used herein, the phrase “player input” refers to any information that may be provided from a player to a player device and/or from the player device to a game controller. Consider, for example, a computer-based maze game. In this case, a player input may represent a player's movement within a maze (e.g., “up,” “down,” “left,” or “right”). Other examples of player inputs include direction information, speed information, timing information, and numerical values.

Game System Overview

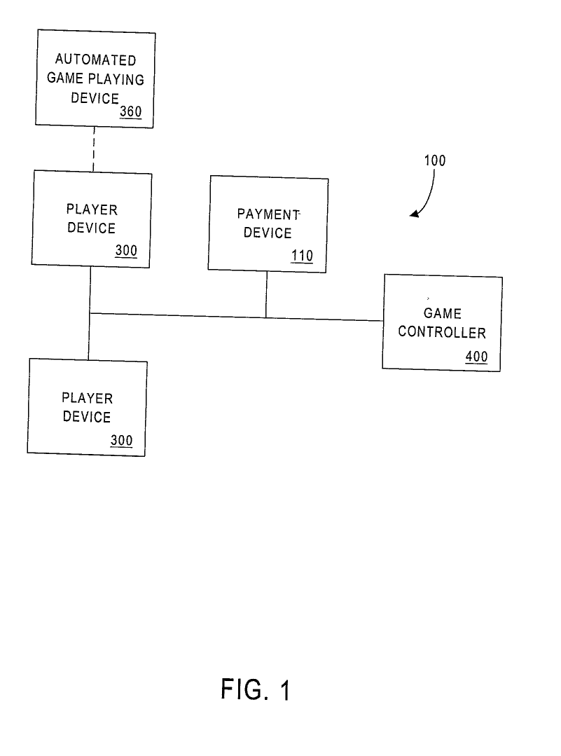

Turning now in detail to the drawings, FIG. 1 is a block diagram of a game system 100 according to one embodiment of the present invention. The game system 100 includes a game controller 400 in communication with a number of remote player devices 300. As used herein, devices (such as the player devices 300 and the game controller 400) may communicate, for example, via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Moreover, as used herein, communications include those enabled by wired or wireless technology. Note that although a single game controller 400 is shown in FIG. 1, any number of game controllers 400 may be included in the game system 100. Similarly, any number of the other devices described herein may be included in the game system 100 according to embodiments of the present invention.

In one embodiment, a player device 300 communicates with a remote, Web-based game controller 400 (e.g., a server) via the Internet. Although some embodiments are described with respect to information exchanged via a game provider's Web site, according to other embodiments information is instead exchanged, for example, via: a telephone, an Interactive Voice Response Unit (IVRU), electronic mail, a WEBTV® interface, a cable network interface, and/or a wireless communication system.

The player device 300 and the game controller 400 may be any devices capable of performing various functions described herein. The player device 300 may be, for example: a PC, a portable computing device such as a Personal Digital Assistant (PDA), a wired or wireless telephone, a one-way or two-way pager, a kiosk (e.g., a game kiosk located at an airport terminal), an interactive television device, a game terminal (e.g., a SONY PLAY STATION® video game terminal), or any other appropriate storage and/or communication device.

Note that the devices shown in FIG. 1 need not be in constant communication. For example, the player device 300 may only communicate with the game controller 400 via the Internet when appropriate (e.g., when attached to a “docking” station or “cradle” coupled to the player's PC). The player device 300 may also communicate with the game controller 400 via an infrared device when near a game kiosk.

A player can use a player device 300 to provide or generate player inputs during game play. For example, a player may use a keyboard or mouse coupled to his or her PC to play a computer-based maze game.

As shown in FIG. 1, a player may also attempt to use an automated game playing device 360 to help him or her during game play. The automated game playing device 360 may be, for example, a modified game program or a separate software program that is being executed on the player device 300. For example, a player may alter an original game program received from a game provider to help him or her play a computer-based maze game. In this case, the automated game playing device 360 may, for example, let the player move through walls or other obstacles within a maze (or even “jump” to a distant location within the maze) providing him or her with an unfair advantage.

The automated game playing device 360 may also be a separate device, including a separate device that mimics signals or other outputs normally generated by the player device 300. For example, the automated game playing device 360 may indicate that the player has performed certain actions in a game that would not normally be possible with the original game program (e.g., by indicating that the player has obtained items that are not present within a maze).

The player device 300 transmits one or more player inputs to the game controller 400 (e.g., indicating that the player has moved “up” and then “left” within a maze). According to the present invention, game play continues at the player device 300 while the game controller 400 determines if the player inputs are valid. For example, the player device 300 may move the player “up” and then “left” before the game controller 400 has determined that those moves are valid based on the particular configuration of the maze.

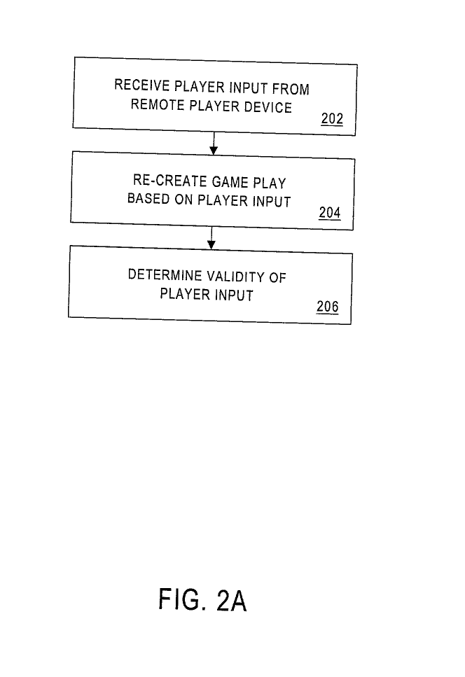

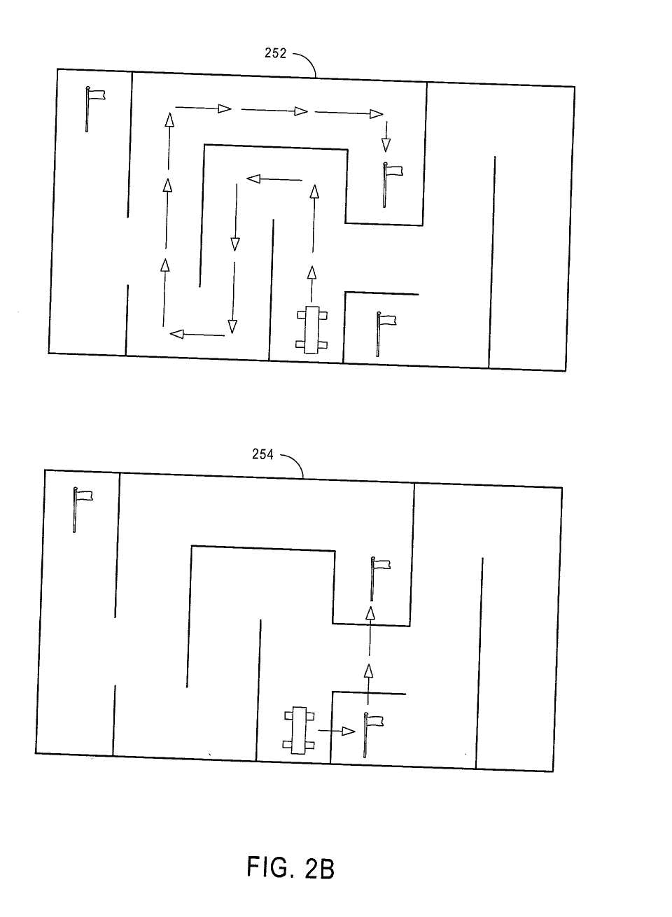

FIG. 2A is a flow chart of a method for facilitating game play according to an embodiment of the present invention. The flow charts in FIG. 2A and the other FIGS. described herein do not imply a fixed order to the steps, and embodiments of the present invention can be practiced in any order that is practicable. Moreover, the methods may be performed by any of the devices described herein. The method shown in FIG. 2A may be performed, for example, by the game controller 400.

At 202, the game controller 400 receives a player input from a remote player device 300. For example, the game controller 400 may receive an indication that a player has moved “up” within a maze. Note that a set of related player inputs can instead be received at the game controller (e.g., a set of player inputs indicating a speed and associated direction).

At 204, game play is re-created at the game controller 400 based on the received player input and a game condition. For example, the game controller 400 may attempt to the move the player within a maze based on the player input. In this way, the game controller 400 determines at 206 whether or not the received player input was valid (e.g., whether or not the player has “moved” through a wall in the maze).

According to the present invention, game play continues at the player device 300 independent of any determination and/or indication of validity from the game controller 400. For example, the player device 400 may display to the player that he or she has moved “up” within the maze, and accept further inputs from the player based on this new location, independent of any determination of validity performed by the game controller 400. That is, continued game play at the player device 300 may occur simultaneously with the determination of validity by the game controller 400.

Note that the game controller 400 may eventually determine and indicate to the player device 300 that the player input was not in fact valid. In this case, the player device 300 may adjust game play (e.g., by moving the player back to his or her last valid location) or simply end the game.

According to another embodiment, game play at the player device 300 continues even when the game controller determines that the player input was not valid. In this case, a game result (e.g., a prize that would have otherwise been awarded to the player) may be adjusted. For example, a game provider may decide to not award a prize to a player when the game controller 400 determines that a player input is not valid.

By way of example, consider the two computer-based maze game displays 252, 254 illustrated in FIG. 2B. Note that although a two-dimensional maze is shown in FIG. 2B for clarity, embodiments of the present invention would similarly apply to three-dimensional mazes.

As shown in the first game display 252, a player has made thirteen moves and obtained one item within the maze (ie., by obtaining a single flag). In this case, the game controller 400 would re-create the player's moves and determine that the player inputs were valid. That is, the thirteen moves and the item obtained by the player were possible given the configuration of the maze. Note that the player continued game play at the player device 300 while the game controller 400 determined the validity of the player inputs. For example, the game controller 400 may have determined that the first ten moves were valid while the player made the last three moves via the player device 300.

Now consider the second game display 254, which illustrates a player who has made three moves and obtained two items within the maze. In this case, the game controller 400 would re-create the player's moves and determine that the player inputs were not valid. That is, the moves made by the player were not possible given the configuration of the maze (i.e., the player has moved through two walls).

According to an embodiment of the present invention, the player device 300 transmits a batch of player inputs to the game controller 400. In this case, the game controller 400 may process the entire batch to determine if each of the player inputs is valid based on one or more game conditions (e.g., a configuration of a maze). Note that the validity of one player input may be based on other player inputs in the batch. For example, the validity of a fourth move within a maze may be based on player's location after the previous three moves are processed. The validity of a player input may also be based on a player's initial location (e.g., an initial location within a maze).

The player device 300 can periodically transmit such a batch of player inputs to the game controller 400. For example, the player device 300 may transmit a batch of player inputs to the game controller 400 after a predetermined number of player moves and/or a predetermined period of time. According to another embodiment, the player device 300 transmits a batch of player inputs in response to a request from the game controller 400.

According to another embodiment, the player device 300 transmits a batch of player inputs to the game controller 400 when an event occurs during game play. For example, a batch of player inputs may be transmitted when a player achieves a goal, completes a game or a game portion (e.g., a level within a game), adjusts a score (e.g., when the player's score is increased by 5,000 points), earns a prize, and/or establishes a game result (e.g., the player obtains an item representing a five dollar prize).

Instead of transmitting a batch of player inputs, the player device 300 may transmit each player input to the game controller 400 as it occurs during game play. In this case, the game controller 400 can evaluate each player input as it is received. According to another embodiment, the game controller 400 stores player inputs to be evaluated (e.g., periodically or when an event occurs during game play).

According to one embodiment, it is arranged for a player to provide payment in exchange for game play. For example, the game controller 400 may arrange for a player to provide payment via a payment identifier associated with a credit card account, a debit card account, a bank account, and/or a digital payment protocol. The game controller 400 may also arrange for a player to receive prize (e.g. payment of a prize amount) based on game play. In this case, the game controller 400 may only provide the prize if it was determined that all of the player inputs were valid (e.g., by “certifying” a game result after re-creating game play). As shown in FIG. 1, a payment device 110 can be used for the player to provide or receive payment (e.g., of a monetary amount or an alternate currency amount such as a gift certificate).

As described above, the present invention may be directed to a game of skill (i.e., a game in which a game result is determined predominately by skill as opposed to chance) such as an arcade-style game in which the player moves within a landscape (e.g., a computer-based maze game). As another example, a player may move about a terrain (e.g., including hills, forests, and streams). In this case, certain movements or speeds may not be valid based on the configuration of the terrain.

According to another embodiment, the game of skill is associated with a physics simulation. For example, the game of skill may be associated with a golf simulation (including a golf putting simulation). Other games that are associated with physics simulations include archery games, moving water games (e.g., white water rafting), racing games, fishing or hunting games, sports games (e.g., baseball, basketball, football, soccer, and hockey games), bowling games, billiards games, throwing games, ring-toss games, shooting games, and space-based games. In such cases, the game condition used to evaluate a player input may comprise, for example, wind information (e.g., a wind speed and direction), atmospheric information, terrain information, and/or object information (e.g., an irregularity in a simulated golf ball). The present invention may also be applicable, for example, with respect to trivia and puzzle games. Of course, a single game may incorporate more than one type of game play (e.g., by including both arcade-style game play and a physics simulation).

Player Device

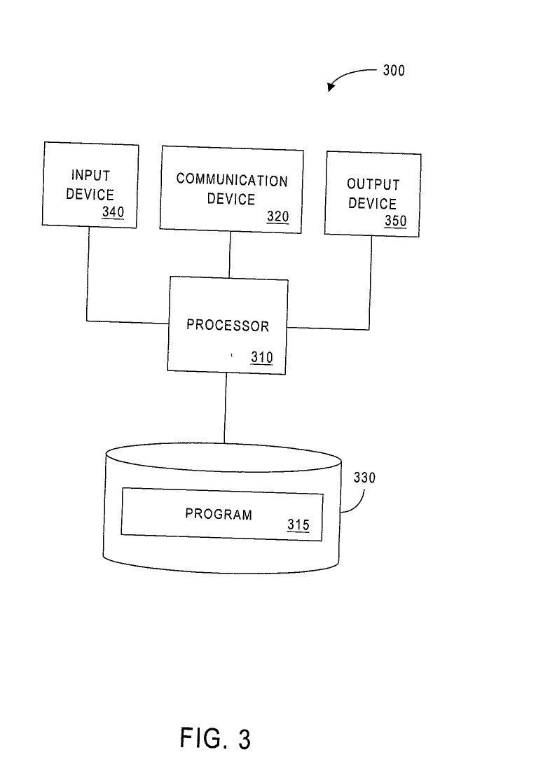

FIG. 3 illustrates a player device 300 that is descriptive of the device shown in FIG. 1 according to an embodiment of the present invention. The player device 300 comprises a processor 310, such as one or more INTEL® Pentium® processors, coupled to a communication device 320 configured to communicate via a communication network (not shown in FIG. 3). The communication device 320 may be used to communicate, for example, with the game controller 400 and/or the payment device 110.

The processor 310 is also in communication with an input device 340. The input device 340 may comprise, for example, a keyboard, a mouse or other pointing device, a microphone, a knob or a switch (including an electronic representation of a knob or a switch), an infrared port, a docking station, and/or a touch screen. Such an input device 340 may be used, for example, to provide player inputs (e.g., by manipulating a pointer associated with a computer-based maze game).

The processor 310 is also in communication with an output device 350. The output device 340 may comprise, for example, a display (e.g., a computer monitor), a speaker, and/or a printer. The output device 350 may be used, for example, to provide game information to a player (e.g., by displaying a maze to a player).

The processor 310 is also in communication with a storage device 330. The storage device 330 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 330 stores a program 315 for controlling the processor 310. The processor 310 performs instructions of the program 315, and thereby operates in accordance with the present invention. For example, the processor 310 may transmit one or more player inputs to a remote game controller 400 and continue game play independent of any indication of validity from the game controller 400.

As used herein, information may be “received” by or “transmitted” to, for example: (i) the player device 300 from the game controller 400; or (ii) a software application or module within the player device 300 from another software application, module, or any other source.

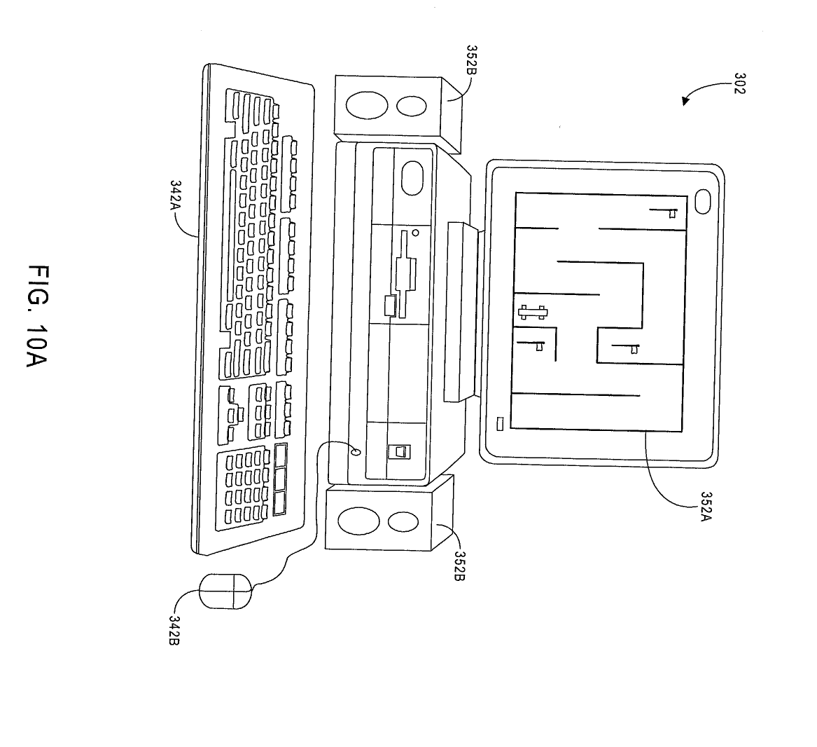

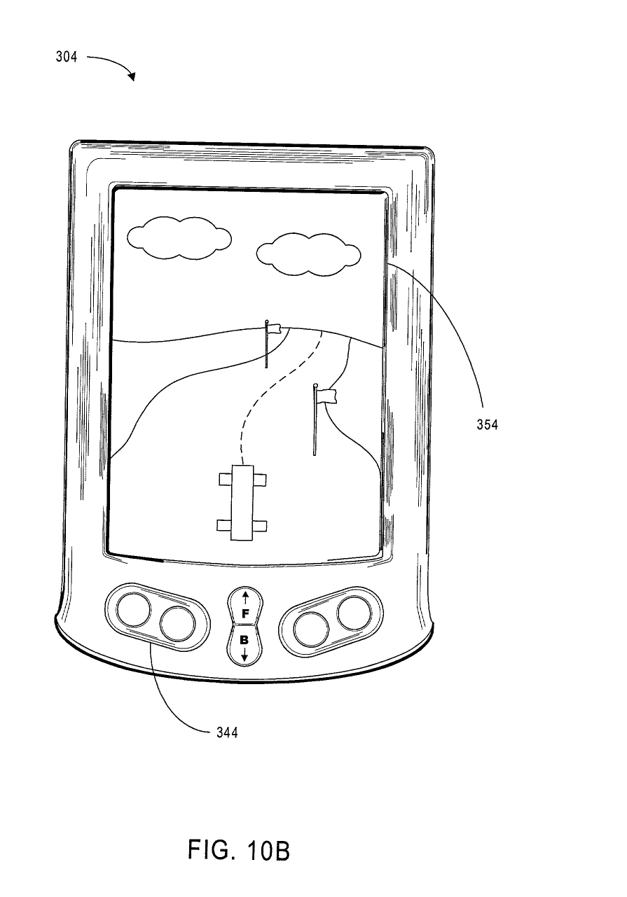

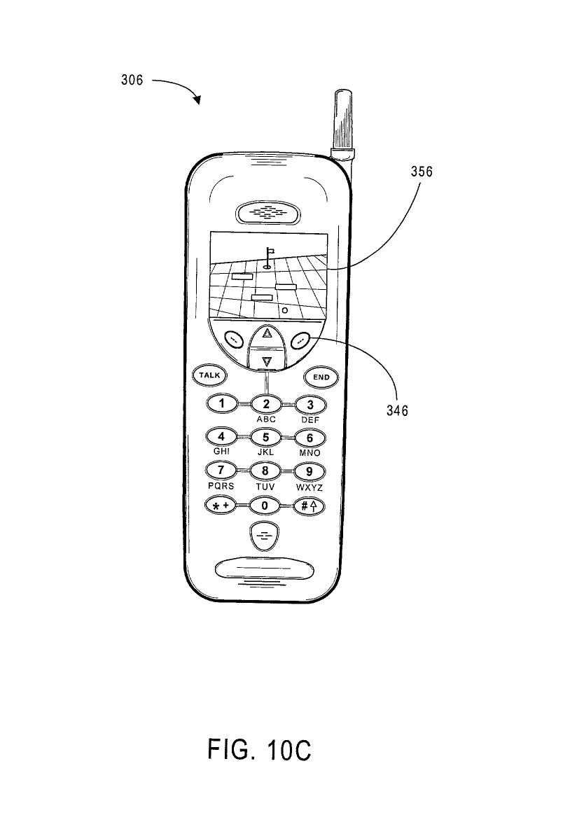

FIG. 10A illustrates a PC 302 displaying a computer-based maze game according to an embodiment of the present invention. The PC 302 includes a keyboard 342A and a mouse 342B which can be used by a player to provide player inputs (e.g., moves within a maze). The PC 302 also includes a computer display 352A and speakers 352B which can be used to, for example, provide game information to a player. In this case, the game controller 400 may determine if a player's move within a maze is valid.

FIG. 10B illustrates a PDA 304 displaying a computer-based racing game according to another embodiment of the present invention. The PDA 304 includes an input device 344 and an output device 354 (e.g., a display screen) that may be used by a player during game play. In this case, the game controller 400 may determine if a player's speed and path along a racing track were valid.

Similarly, FIG. 10C illustrates a wireless telephone 306 including an input device 346 and an output device 356 displaying a computer-based golf game. In this case, the game controller 400 may determine whether or not a series of golf putts made by a player were valid.

Game Controller

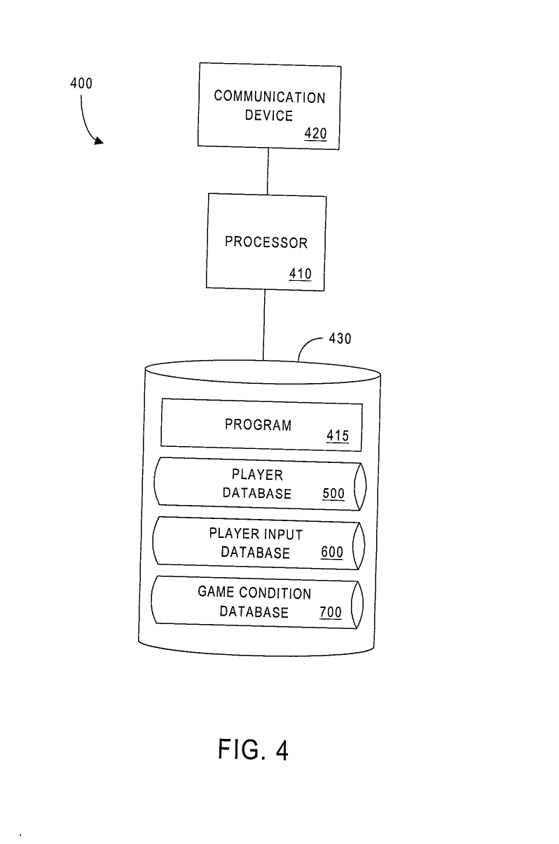

FIG. 4 illustrates a game controller 400 that is descriptive of the device shown in FIG. 1 according to an embodiment of the present invention. The game controller 400 comprises a processor 410, such as one or more INTEL® Pentium® processors, coupled to a communication device 420 configured to communicate via a communication network (not shown in FIG. 4). The communication device 420 may be used to communicate, for example, with one or more player devices 300 and/or the payment device 110.

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as RAM devices and ROM devices.

The storage device 430 stores a program 415 for controlling the processor 410. The processor 410 performs instructions of the program 415, and thereby operates in accordance with the present invention. For example, the processor 410 may receive a player input from a remote player device 300 and determine if the received player input is valid based on a game condition.

According to one embodiment, the processor 410 arranges for the player to provide payment in exchange for game play. The processor 410 also receives a batch of player moves from a remote player device 300 and re-creates game play to determine if each of the received batch of player moves is valid. The processor 410 may also certify a game result (assuming all of the player moves are valid) and arrange for the player to receive payment of a monetary amount based on the certified game result.

The program 415 may be stored in a compressed, uncompiled and/or encrypted format. The program 415 may furthermore include other program elements, such as an operating system, a database management system, and/or device drivers used by the processor 410 to interface with peripheral devices.

As used herein, information may be “received” by or “transmitted” to, for example: (i) the game controller 400 from the player device 300; or (ii) a software application or module within the game controller 400 from another software application, module, or any other source.

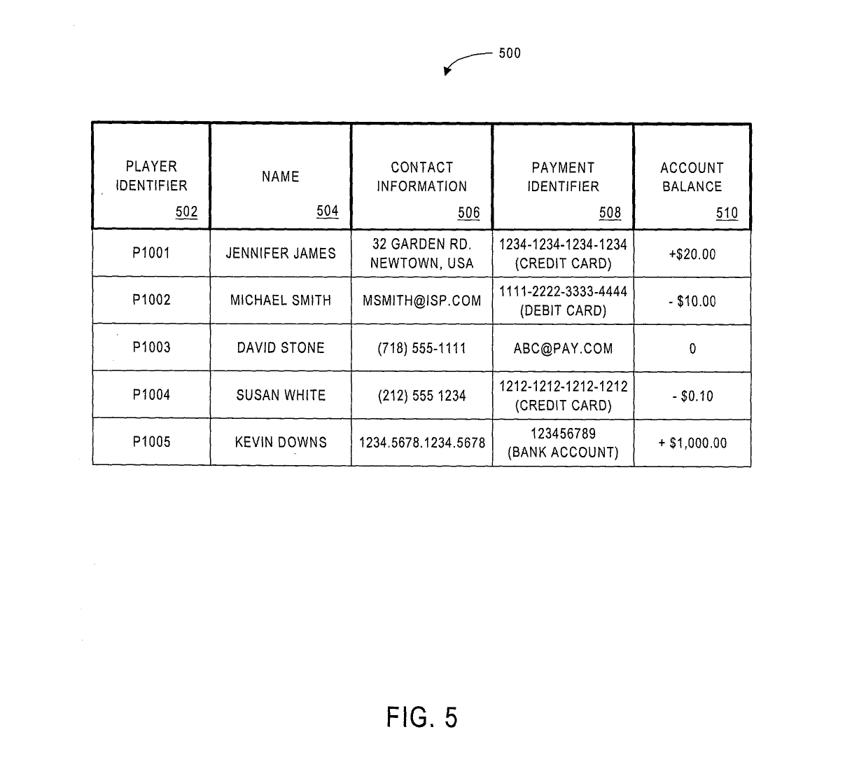

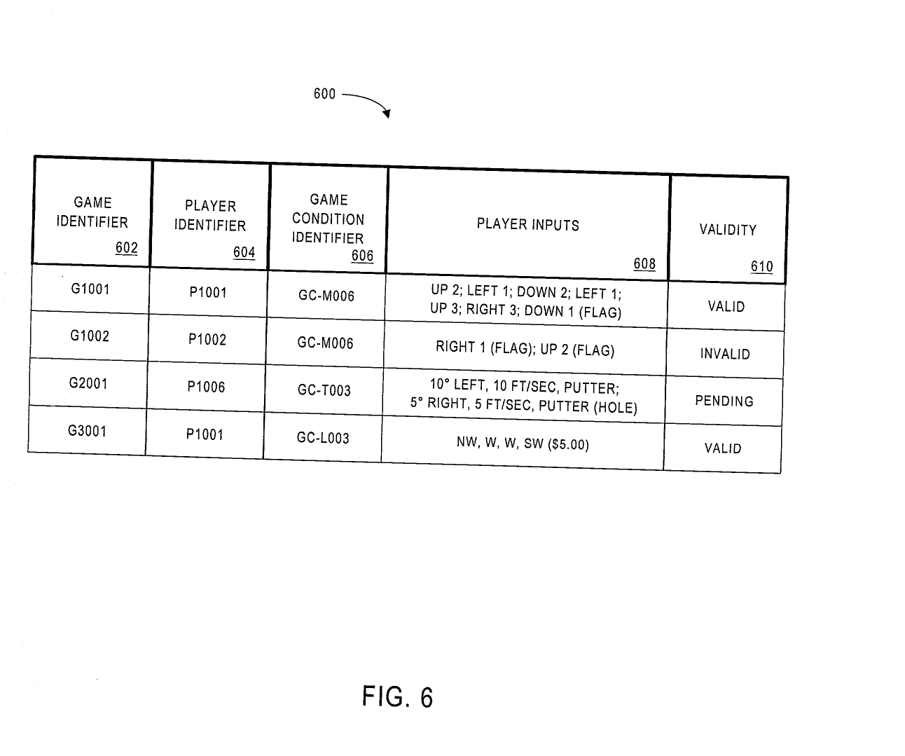

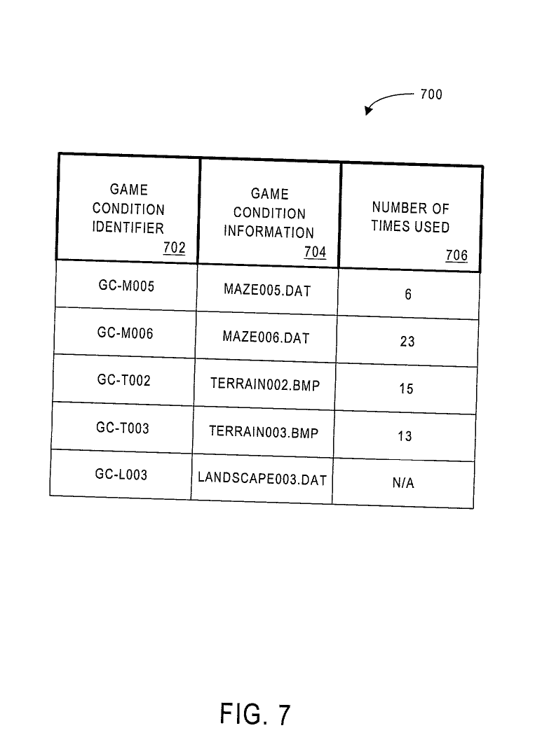

As shown in FIG. 4, the storage device 430 also stores a player database 500 (described with respect to FIG. 5), an player input database 600 (described with respect to FIG. 6), and a game condition database 700 (described with respect to FIG. 7). Examples of databases that may be used in connection with the game system 100 will now be described in detail with respect to FIGS. 5 through 7. The illustrations and accompanying descriptions of the databases presented herein are exemplary, and any number of other database arrangements could be employed besides those suggested by the figures.

Player Database

Referring to FIG. 5, a table represents the player database 500 that may be stored at the game controller 400 according to an embodiment of the present invention. The table includes entries identifying players who may play games via the game system 100. The table also defines fields 502, 504, 506, 508, 510 for each of the entries. The fields specify: a player identifier 502, a name 504, contact information 506, a payment identifier 508, and an account balance 510. The information in the player database 500 may be created and updated, for example, based on information received from player when he or she registers with the game controller 400. The information in the player database 500 may also be based on, for example, information generated as the player plays games via the game system 100.

The player identifier 502 may be, for example, an alphanumeric code associated with a player who has registered to use the game system 100. The player identifier 502 may be generated by, for example, the game controller 400 or the player (e.g., when he or she provides a user name and password). The player database 500 also stores the name 504 and contact information 506 (e.g., a postal address, an electronic mail address, an IP address, or a telephone number) associated with each player.

The payment identifier 508 may comprise, for example, a credit card, debit card or bank account number (e.g., a checking account number) or digital payment protocol information. The account balance 510 may represent, for example, an amount that a player owes to a game provider or an amount that the game provider owes to the player. The payment identifier 508 and the account balance 510 may be used, for example, by the game controller 400 to arrange for the player to provide or receive a payment (e.g., based on a certified game result).

Player Input Database

Referring to FIG. 6, a table represents the player input database 600 that may be stored at the game controller 400 according to an embodiment of the present invention. According to another embodiment, some of the information in the player input database 600 is instead stored at a player device 300 (e.g., while being queued for transmission to the game controller 400 as a batch of player inputs). The table includes entries identifying games that have been played by a player along with player inputs to be verified by the game controller. The table also defines fields 602, 604, 606, 608, 610 for each of the entries. The fields specify: a game identifier 602, a player identifier 604, a game condition identifier 606, one or more player inputs 608, and an indication of validity 610. The information in the player input database 600 may be created and updated, for example, as players play games via the game system 100.

The game identifier 602 may be, for example, an alphanumeric code associated with a game that has been (or is being) played via the game system 100. The player identifier 604 represents a player who is playing the game and may be based on, or associated with, the player identifier 502 stored in the player database 500.

The game condition identifier 606 is associated with one or more game conditions that are used to determine if a player input is valid. For example, the game controller 400 may re-create game play (e.g., moves within a maze) based on the game condition identifier 606 to determine if a player input is valid.

The player inputs 608 represent one or more player inputs that have been provided by a player during game play. For example, the player inputs 608 may represent movements within a maze. In general, the player inputs 608 may comprise any information provided by the player or the player device 300 during game play.

The indication of validity 610 represents a determination by the game controller 400 of whether or not the player inputs 608 were valid in view of a game condition (i.e., that the game condition associated with the game condition identifier 606). The validity 610 may indicate, for example, that the player inputs 608 are “valid,” “invalid,” or “pending” (i.e., the game controller 400 has not yet determined if the player inputs 608 are valid). Note that the first entry illustrated in FIG. 6 is associated with the first game display 252 shown in FIG. 2B and the second entry is associated with the second game display 254.

Game Condition Database

Referring to FIG. 7, a table represents the game condition database 700 that may be stored at the game controller 400 according to an embodiment of the present invention. The table includes entries associated with game conditions used during game play. The table also defines fields 702, 704, 706 for each of the entries. The fields specify: a game condition identifier 702, game condition information 704, and an indication of a number of times the game condition has been used 706 during game play. The information in the game condition database 700 may be created and updated, for example, by the game controller 400.

The game condition identifier 702 may be, for example, an alphanumeric code associated with a game condition used during game play. Note that the game condition identifier 702 may be based on, or associated with, the game condition identifier 606 stored in the player input database 600.

The game condition information 704 represents information used by the player device 300 and/or the game controller 400 during game play. For example, the game condition information 704 may represent a particular maze configuration. In general, the game condition information 704 may comprise any information that is used by the game controller 400 to determine if a player input is valid. Note that the game condition information 704 may be associated with a particular game or may be associated with multiple games and/or multiple players (e.g., pre-stored game condition information 704 may be used during multiple games). The number of times used 706 associated with the game condition information 704 may prevent the same game condition information 704 from being used too often.

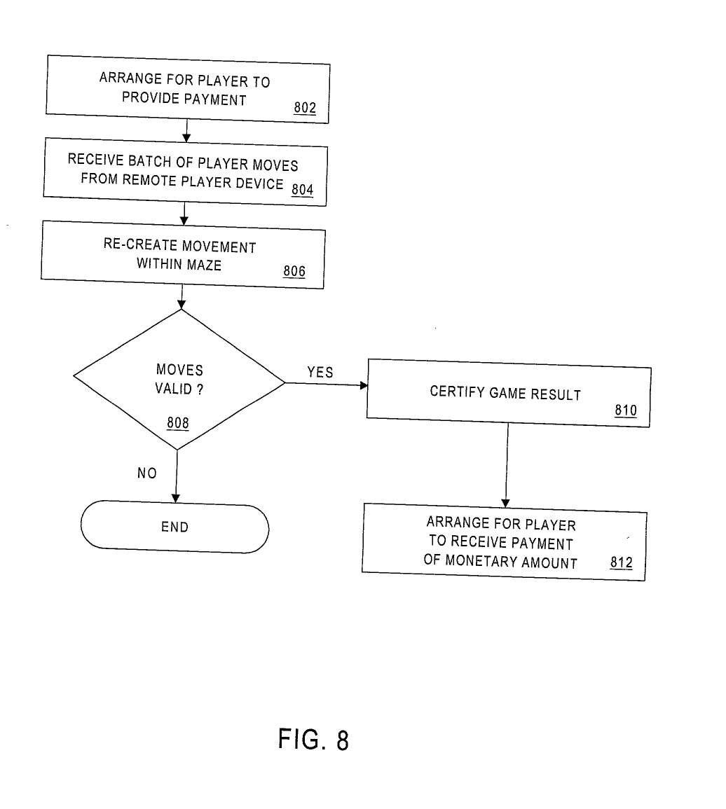

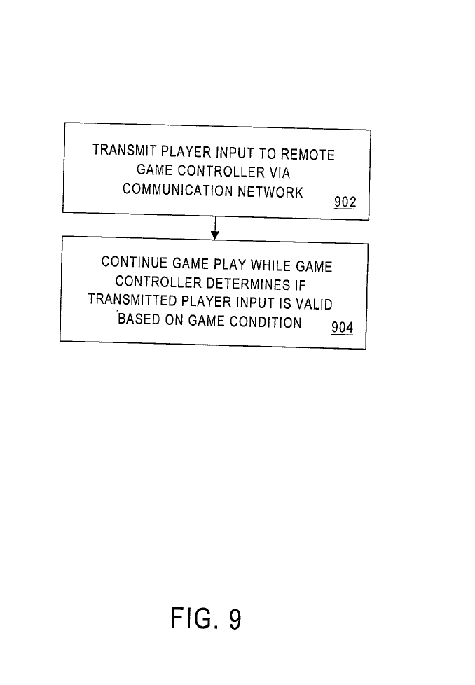

Methods that may be used in connection with the game system 100 according to some embodiments of the present invention will now be described in detail with respect to FIGS. 8 and 9.

Game System Methods

FIG. 8 is a flow chart of a computer-implemented method for facilitating game play at a game controller 400. In this case, game play is associated with a game of skill in which a player moves within a maze. At 802, it is arranged for the player to provide a payment in exchange for playing a game. For example, the game controller 400 may transmit a payment identifier 508 to a payment device 110 to arrange for the player to provide a payment of $1.00 in exchange for game play.

At 804, a batch of player moves are received from a remote player device 300 via a communication network such as the Internet. For example, the game controller 400 may receive the batch of player moves whenever the player obtains an item within the maze (e.g., captures a flag as shown in FIG. 2B). The batch of player moves may be stored, for example, as player inputs 608 in the player input database 600.

At 806, the game controller 400 re-creates game play to determine if each of the received batch of player moves is valid. For example, the game controller 400 may process each of the player inputs 608 stored in the player input database 600 based on game condition information 704 (i.e., a configuration of the maze) stored in the game condition database 700.

If all of the player moves are valid at 808, the game controller 400 certifies a game result (e.g., a number of flags obtained by the player) at 810 and arranges for the player to receive payment of a monetary amount (i.e., a prize) based on the certified game result at 812.

FIG. 9 is a flow chart of a method that may be performed by a player device 300 according to an embodiment of the present invention. At 902, a player input is transmitted to a remote game controller 400 via a communication network. For example, the player device 300 may store player moves as a player navigates through a maze. When the player obtains an item in the maze (e.g., obtains a flag located within the maze), the player device 300 can send a batch of stored player moves to the game controller 400 (e.g., representing all of the moves that the player has made since the last batch was sent).

At 904, the player device 300 arranges for game play to continue while the game controller 400 determines if the player input was valid. In other words, the player device 300 does not wait for an indication of validity to be received from the game controller 400. Note that an indication of validity (or invalidity) may eventually be received by the player device 300 from the game controller 400. If an indication of invalidity is eventually received, the player device 300 can adjust game play (e.g., be re-locating the player to another position) or simply end the game.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

According to one embodiment, the player device 300 does not continue game play while the game controller 400 evaluates one or more player inputs. Instead, smooth, fast paced game play is provided by having the player device 300 store a batch of player inputs to be provided to the game controller 400 upon an occurrence of an event during game play. In this case, the game controller 400 can determined if each of the received batch of player inputs is valid based on a game condition. For example, the player device 300 may send a batch of player inputs to the game controller 400 (an pause game play) when a player achieves a goal, completes a game or portion of a game, adjusts his or her score, earns a prize, and/or establishes a game result. Note that, in this case, the validity of one of the player inputs in the batch may be based on other player inputs in the batch (e.g., the validity of one move within a maze may be based on other moves the player has made).

Although most of the embodiments described herein are associated with a game controller 400 determining whether a player input is valid, according to still another embodiment this function is instead performed by a player device 300. Consider, for example, a game in which a first player at a first player device 300 plays against a second player at a second player device 300. In this case, the first player device 300 may send a batch of player inputs to the second player device 300, which in turn validates the information (i.e., while game play continues at the first player device 300). Similarly, although most of the embodiments described herein are associated with a game played by a single player, the present invention can also be used with respect to games involving multiple players (e.g., teams of players).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating game play at a game controller, comprising:
receiving a player input from a remote player device via a communication network; and
determining if the received player input is valid based on a game condition, wherein the remote player device continues game play independent of any indication of validity from the game controller.

2. The method of claim 1, wherein said receiving comprises:
receiving a batch of player inputs, and
said determining comprises:
determining if each of the received batch of player inputs is valid based on the game condition.

3. The method of claim 2, wherein the validity of one of the player inputs in the batch is further based on other player inputs in the batch.

4. The method of claim 2, wherein the batch of player inputs is received upon an occurrence of an event during game play.

5. The method of claim 4, wherein the event comprises at least one of: (i) achieving a goal, (ii) completing a game, (iii) completing a game portion, (iv) adjusting a score, (v) earning a prize, and (vi) establishing a game result.

6. The method of claim 2, wherein the batch of player inputs is received periodically.

7. The method of claim 6, wherein the batch of player inputs is received based on at least one of: (i) a predetermined number of player moves, and (ii) a predetermined period of time.

8. The method of claim 2, wherein the batch of player inputs is received in response to a request transmitted from the game controller to the remote player device.

9. The method of claim 8, wherein game play is associated with moves within a landscape, and the batch of player inputs comprises a batch of player moves.

10. The method of claim 9, wherein the landscape comprises a maze.

11. The method of claim 10, wherein the game condition is associated with at least one of: (i) a player location, and (ii) valid player moves within the maze.

12. The method of claim 1, further comprising:
storing a plurality of received player inputs,
wherein said determining comprises determining if the plurality of stored player inputs are valid based on the game condition

13. The method of claim 1, wherein said determining comprises re-creating game play at the game controller based on the received player input and the game condition.

14. The method of claim 1, further comprising:
transmitting an indication of validity to the remote player device.

15. The method of claim 1, further comprising:
arranging for a player to provide payment in exchange for game play.

16. The method of claim 15, wherein said arranging is performed via at least one of: (i) a payment identifier, (ii) a credit card account, (iii) a debit card account, (iv) a bank account, and (v) a digital payment protocol.

17. The method of claim 15, further comprising:
certifying a game result based on said determining.

18. The method of claim 17, further comprising:
arranging for the player to receive a prize based on the certified game result.

19. The method of claim 18, wherein the prize comprises payment of at least one of: (i) a monetary amount, and (ii) an alternate currency amount.

20. The method of claim 19, wherein game play is associated with a game of skill.

21. The method of claim 20, where in the game of skill comprises an arcade-style game in which the player moves within a landscape.

22. The method of claim 21, wherein the landscape comprises a maze, and the game condition is associated with at least one of: (i) a player location, and (ii) valid player moves within the maze.

23. The method of claim 20, wherein the game of skill is associated with a physics simulation.

24. The method of claim 23, wherein the game of skill comprises at least one of: (i) a golf simulation; (ii) a golf putting simulation; (iii) an archery simulation; (iv) a moving water simulation; (v) a racing simulation; (vi) a fishing simulation; (vii) a baseball simulation; (viii) a basketball simulation; (ix) a football simulation; (x) a soccer simulation; (xi) a hockey simulation; (xii) a bowling simulation; (xiii) a billiards simulation; (xiv) a throwing simulation; (xv) a ring-toss simulation; (xvi) a shooting simulation; and (xvii) a space simulation.

25. The method of claim 23, wherein the game condition comprises at least one of: (i) wind information, (ii) a wind speed, (iii) a wind direction, (iv) atmospheric information, (v) terrain information, and (vi) object information.

26. The method of claim 20, wherein the game of skill comprises at least one of: (i) a trivia game, and (ii) a puzzle game.

27. The method of claim 1, wherein the remote player device comprises at least one of: (i) a personal computer, (ii) a portable computing device, (iii) a personal digital assistant, (iv) a telephone, (v) a wireless telephone, (vi) a game terminal, (vii) an interactive television device, and (viii) a kiosk.

28. The method of claim 1, wherein the communication network comprises at least one of: (i) the Internet, (ii) a public network, (iii) a public switched telephone network, (iv) a proprietary network, (v) a cable television network, (vi) a wireless network, and (vii) a local area network.

29. A game controller, comprising:
a processor; and
a storage device in communication with said processor and storing instructions adapted to be executed by said processor to:
receive a player input from a remote player device via a communication network; and
determining if the received player input is valid based on a game condition, wherein the remote player device continues game play independent of any indication of validity from the game controller.

30. The game controller of claim 29, wherein said storage device further stores at least one of: (i) a player database, (ii) a player input database, and (iii) a game condition database.

31. The game controller of claim 29, further comprising:
a communication device coupled to said processor and adapted to communicate with at least one of: (i) the remote player device, and (ii) a payment device.

32. A medium storing instructions adapted to be executed by a processor to perform a method of facilitating game play at a game controller, said method comprising:
receiving a player input from a remote player device via a communication network; and
determining if the received player input is valid based on a game condition, wherein the remote player device continues game play independent of any indication of validity from the game controller.

33. A method of facilitating game play at a game controller, wherein game play is associated with a game of skill in which a player moves within a maze, comprising:
arranging for the player to provide payment in exchange for game play;
receiving a batch of player moves from a remote player device via a communication network;
re-creating game play at the game controller to determine if each of the received batch of player moves is valid;
certifying a game result if each of the received batch of player moves is valid; and
arranging for the player to receive payment of a monetary amount based on the certified game result.

34. A method of facilitating game player at a player device, comprising:
transmitting a player input to a remote game controller via a communication network; and
continuing game play independent of any indication of validity from the game controller, wherein the game controller determines if the transmitted player input is valid based on a game condition.

35. The method of claim 34, further comprising:
receiving an indication that the transmitted player input is invalid; and
adjusting game play based on the received indication.

36. The method of claim 34, further comprising:
storing a batch of player inputs at the player device, wherein said transmitting comprises transmitting the batch of player inputs to the game controller.

37. A method of facilitating game play at a game controller, comprising:
receiving a batch of player inputs from a remote player device via a communication network upon an occurrence of an event during game play; and
determining if each of the received batch of player inputs is valid based on a game condition.

38. The method of claim 37, wherein the validity of one of the player inputs in the batch is further based on other player inputs in the batch.

39. The method of claim 37, wherein the event comprises at least one of: (i) achieving a goal, (ii) completing a game, (iii) completing a game portion, (iv) adjusting a score, (v) earning a prize, and (vi) establishing a game result.
